(19) United States
(12) Patent Application Publication
(10) Pub. No.: US 2014/0047301 A1
(43) Pub. Date: Feb. 13, 2014

(54) SEMICONDUCTOR MEMORY DEVICE AND A METHOD THEREIN

(71) Applicant: Renesas Electronics Corporation, Kawasaki-shi (JP)

(72) Inventor: Mamoru KURATA, Tokyo (JP)

(73) Assignee: Renesas Electronics Corporation, Kawasaki-shi (JP)

(21) Appl. No.: 13/957,615

(22) Filed: Aug. 2, 2013

(30) Foreign Application Priority Data
Aug. 9, 2012 (JP) 2012-177009

(51) Int. Cl. G06F 11/10

(52) U.S. Cl. CPC G06F 11/1008
USPC 714/773

(57) ABSTRACT

The disclosed semiconductor memory device includes an operating environment information storing unit for storing memory characteristics representing a correlation between an operating environment of a first memory unit and a data error rate; first and second error correction units making a stepwise correction of a bit error in data, based on data stored in the first memory unit; an error rate estimation unit that compares each of parameters retained in an access counts retaining unit, a temperature information retaining unit, and a data retention period retaining unit with relevant memory characteristics and estimates an error rate of data to be accessed within the memory, and a power supply controller that controls power supply to the second error correction unit depending on an error correction step, based on the estimated error rate.

### CROSS-REFERENCE TO RELATED APPLICATIONS

The disclosure of Japanese Patent Application No. 2012-177009 filed on Aug. 9, 2012 including the specification, drawings and abstract is incorporated herein by reference in its entirety.

### BACKGROUND

The present invention relates to a semiconductor memory device having error correction functions and particularly to a technique for controlling power consumption.

In semiconductor memory devices provided with a non-volatile memory or the like, diverse schemes of error correction and the like are used to enhance the reliability of data that is stored in the memory. Along with such error correction schemes, techniques for power consumption reduction are also being developed.

For example, a semiconductor memory device uses a plurality of types of error correction schemes and applies the error correction schemes in a stepwise fashion. Japanese Unexamined Patent Publication No. 2009-80651 (Patent Document 1) discloses a technique that applies error correction schemes in a stepwise fashion in order to reduce power consumption and circuit size without impairing the capability of error correction. According to the technique described in Patent Document 1, if no error is present in all data that has been read as a result of error correction processing, a semiconductor memory device does not execute subsequent error correction processing, thereby achieving power consumption reduction. Japanese Unexamined Patent Publication No. 2009-211209 (Patent Document 2) discloses a technique that performs a plurality of types of error coding with different capabilities of error correction, when applying an error correction scheme to a memory such as a flash memory in which bad bits are present. Japanese Unexamined Patent Publication No. 2009-59422 (Patent Document 3) discloses an error correction technique for reducing power consumption of a flash memory.

### RELATED ART DOCUMENTS

### Patent Documents

[Patent Document 1] Japanese Unexamined Patent Publication No. 2009-80651
[Patent Document 2] Japanese Unexamined Patent Publication No. 2009-211209
[Patent Document 3] Japanese Unexamined Patent Publication No. 2009-59422

### SUMMARY

However, there are various factors of unsettling the operation of a semiconductor memory device. Consequently, data that is retained in the semiconductor memory device is at risk of data inversion due to these various factors. Therefore, there is a need for a semiconductor memory device that achieves power consumption reduction, while responding to these factors of unsettling the operation of the semiconductor memory device.

Other objects and novel features of the present invention will become apparent from the following description in the present specification and the accompanying drawings.

A semiconductor memory device according to an embodiment includes a storage unit for storing one or more sorts of operating environment information which represents a correlation between an operating environment of a memory and a data error rate; an error correction unit having a plurality of error correction functions for correcting, based on data that is stored in the memory, a bit error in the data; an estimation unit that retrieves an operating environment parameter indicating an operating environment of the memory and estimates an error rate of data that is to be accessed within the memory, based on the operating environment information and the operating environment parameter; and a control unit that selects at least one of the error correction functions to be used for error correction based on the estimated error rate and supplies power to at least one circuit implementing the selected at least one of the error correction functions.

According to the semiconductor memory device according to an embodiment, it is possible to enhance the reliability of data retained by the semiconductor memory device, while achieving power saving.

### BRIEF DESCRIPTION OF THE DRAWINGS

FIG. 1 is a block diagram depicting a configuration of a semiconductor memory device 1.

FIG. 2 is a graph presenting a correlation between an access count to a first memory unit 22 and a data error rate.

FIG. 3 is a graph presenting a correlation between an operating temperature of the first memory unit 22 and a data error rate.

FIG. 4 is a graph presenting a correlation between a data retention period of the first memory unit 22 and a data error rate.

FIG. 5 is a flowchart illustrating operation of an error rate estimation unit 12.

FIG. 6 is a flowchart illustrating how memory access and error correction are controlled by a memory access controller 14.

FIG. 7 is a flowchart illustrating operation of the semiconductor memory device 1, if power supply to a second error correction unit 30 is turned OFF.

### DETAILED DESCRIPTION

An embodiment of the present invention will be described below with reference to the drawings. In the following description, identical components are assigned the same reference numerals. They have identical names and functions. Therefore, their detailed description is not repeated.

### <Configuration>

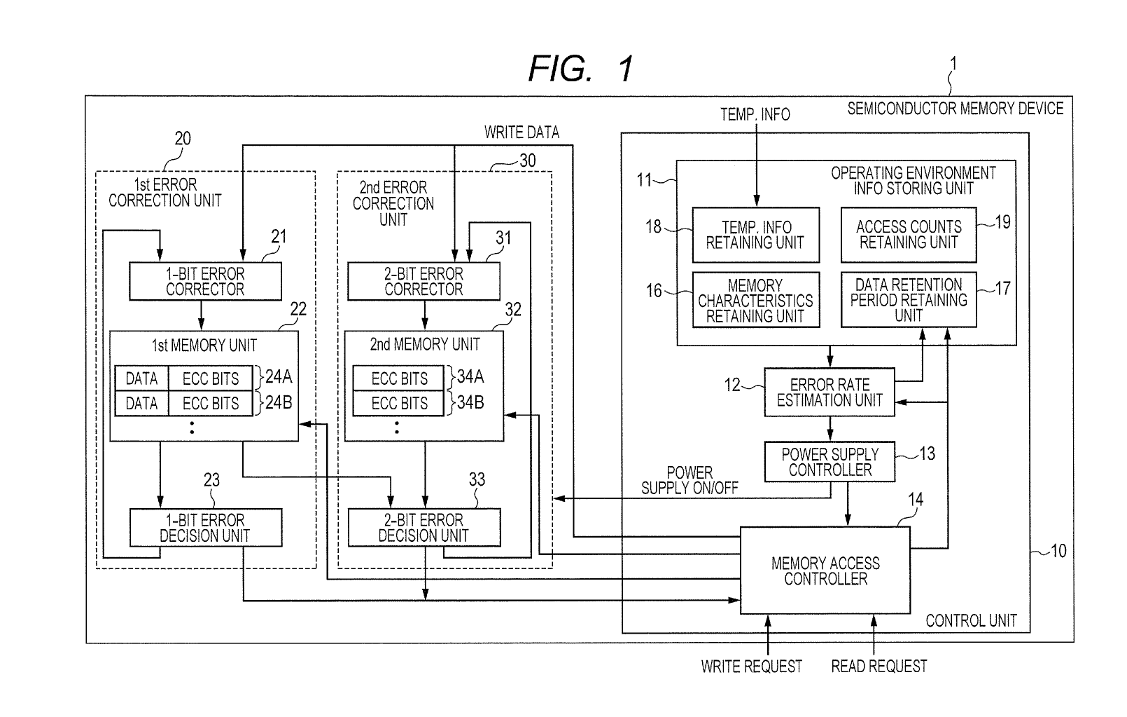

FIG. 1 is a block diagram depicting a configuration of a semiconductor memory device 1.

As depicted in FIG. 1, the semiconductor memory device 1 includes a control unit 10, a first error correction unit 20, and a second error correction unit 30.

The control unit 10 includes an operating environment information storing unit 11, an error rate estimation unit 12, a power supply controller 13, and a memory access controller 14, and controls power supply to the second error correction unit 30, as will be described later.

The operating environment information storing unit 11 is comprised of memory elements and retains various parameters indicating an operating environment of the semiconductor memory device 1. The operating environment information storing unit 11 includes a memory characteristics retaining unit 16, an access counts retaining unit 17, a temperature information retaining unit 18, and a data retention period retaining unit 19.

The memory characteristics retaining unit 16 retains memory characteristics of a first memory unit 22 and a second memory unit 32. Memory characteristics represent a correlation between an operating environment of a memory and a data error rate of the memory. The operating environment of a memory involves access counts to the memory, a period of data retention in the memory, an operating temperature of the memory, etc. Memory characteristics will be detailed later.

The access counts retaining unit 17 associatively stores each address in a memory such as the first memory unit 22 retaining data which is read or written by the semiconductor memory device 1 and the count of access to the address. In the access counts retaining unit 17, access counts to the memory are managed in units of lines of the memory.

The temperature information retaining unit 18 retains an operating temperature of the semiconductor memory device 1. A temperature sensor which is not depicted measures an operating temperature of the first memory unit 22 and an output value of this temperature sensor is stored from moment to moment into the temperature information retaining unit 18.

The data retention period retaining unit 19 associatively stores each address in a memory such as the first memory unit 22 and a retention period in which data is retained at the address. In the data retention period retaining unit 19, data retention periods in a memory are managed in units of lines of the memory.

The error rate estimation unit 12 estimates an error rate of data in the first memory unit 22, based on the memory characteristics which are stored in the memory characteristics retaining unit 16 and the respective parameters (indicating the operating environment of the memory) which are stored in the access counts retaining unit 17, the temperature information retaining unit 18, and the data retention period retaining unit 19, and outputs a result of the estimation. For example, the error rate estimation unit 12 estimates an error rate of data and outputs a value indicating either a “high” or “low” error rate to the power supply controller 13.

The power supply controller 13 controls power supply to the second error correction unit 30, depending on a value indicating an estimated error rate which is output by the error rate estimation unit 12. For example, if an estimation result which is output by the error rate estimation unit 12 indicates a “high” error rate, the power supply controller 13 supplies power to the second error correction unit 30; if the estimation result is a “low” error rate, the power supply controller 13 stops power supply to the second error correction unit 30.

The memory access controller 14 controls a data write operation (writing) to the first memory unit 22 and a data read operation (reading) from the first memory unit 22 in response to a data write request or a data read request from an external entity which is not depicted. The memory access controller 14 outputs an address signal indicating a memory address that is to be accessed to a row decoder and a column decoder in order to access a memory cell array included in the first memory unit 22. Also, the memory access controller 14 outputs various signals to activate a word line, a bit line, a sense amplifier, etc. for accessing a memory cell included in the first memory unit 22 and the second memory unit 32. The memory access controller 14 outputs write data which is written to the first memory unit 22 to a 1-bit error corrector 21 and a 2-bit error corrector 31. The memory access controller 14 receives read data from the first memory unit 22. The memory access controller 14 receives a result of error decision made in the first error correction unit 20 and the second error correction unit 30, which will be described later, and performs processing for displaying an error in case of an uncorrectable error.

The first error correction unit 20 includes the 1-bit error corrector 21, the first memory unit 22, and a 1-bit error decision unit 23 and retains data which is read or written in the semiconductor memory device 1. The first error correction unit 20 has an error correction function to enhance reliability of data it retains.

The 1-bit error corrector 21 generates ECC (Error-Correcting Code) bits for correcting a 1-bit error, based on write data which is written to the first memory unit 22.

The first memory unit 22 is configured with a non-volatile memory or the like and, for each address, associatively retains write data to the semiconductor memory device 1 and ECC bits generated by the 1-bit error corrector 21 and associated with the write data. In FIG. 1, contents held in first memory unit 22 are represented as stored data and ECC bits 24A, stored data and ECC bits 24B, and so forth.

The 1-bit error decision unit 23 determines whether data retained in the first memory unit 22 is in error, based on its associated ECC bits retained in the first memory unit 22. If the 1-bit error decision unit 23 determines that data is in error and one bit in error can be corrected by the ECC bits, it outputs corrected data to the 1-bit error corrector 21. The 1-bit error decision unit 23 outputs data read from the first memory unit 22 to the memory access controller 14. Also, the 1-bit error decision unit 23 outputs a result of error decision to the memory access controller 14.

The second error correction unit 30 includes the 2-bit error corrector 31, the second memory unit 32, and a 2-bit error decision unit 33 and exerts a more robust error correction function than the first error correction unit 20. Whereas the first error correction unit 20 is able to correct a 1-bit error and detect a 2-bit error, the second error correction unit 30 is able to correct a 2-bit error and detect a 3-bit error.

The 2-bit error corrector 31 generates ECC bits for correcting a 2-bit error, based on write data which is output from the memory access controller 14.

The second memory unit 32 is configured with a non-volatile memory or the like and associatively retains write data for each address in the first memory unit 22 and ECC bits generated by the 2-bit error corrector 31 and associated with the write data. In FIG. 1, contents held in second memory unit 32 are represented as ECC bits 34A, ECC bits 34B, and so forth.

The 2-bit error decision unit 33 determines whether data retained in the first memory unit 22 is in error, based on its associated ECC bits retained in the second memory unit 32. If the 2-bit error decision unit 33 determines that data is in error and two bits in error can be corrected by the ECC bits, it outputs corrected data to the 2-bit error corrector 31. The 2-bit error decision unit 33 outputs a result of error decision to the memory access controller 14.

By having the configuration described above, the semiconductor memory device 1 estimates a probability that data retained in a memory may be in error, based on the operating conditions and operating environment of the memory such as non-volatile memory, and makes the second error correction unit 30 exert its data correction function, if there is a high probability that data may be in error. On the other hand, if there is a low probability that data retained in the memory may be in error, the semiconductor memory device 1 constrains power supply to the second error correction unit 30. Accordingly, the semiconductor memory device 1 can operate without making excessive use of error correction functions, depending on the operating conditions and operating environment of the memory, and achieves power consumption reduction.

### <Data>

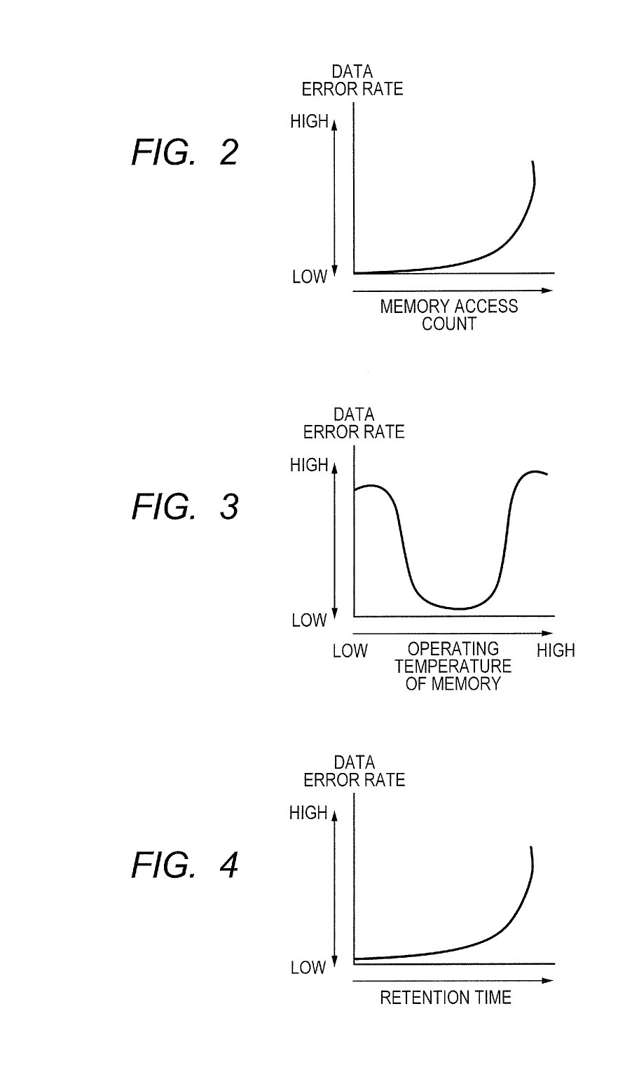

Referring to FIG. 2 and so on, an explanation is then provided for memory characteristics of the first memory unit 22 which are retained in the memory characteristics retaining unit 16.

FIG. 2 is a graph presenting a correlation between an access count to the first memory unit 22 and a data error rate. The memory deteriorates and its capability of data retention decreases, as its access count increases. As presented in FIG. 2, as a cumulative access count to an address in the memory increases, the data error rate rises. Consequently, the reliability of data retained at an address that is accessed frequently will decrease.

FIG. 3 is a graph presenting a correlation between an operating temperature of the first memory unit 22 and a data error rate. As presented in FIG. 3, the memory has a temperature zone suitable for operation and, when its operating temperature is higher or lower than the temperature zone, the error rate of data retained in the memory rises.

FIG. 4 is a graph presenting a correlation between a data retention period of the first memory unit 22 and a data error rate. The retention period is time elapsed since the memory was last accessed. As presented in FIG. 4, when the memory is not accessed for a long period, there is an increasing possibility of inversion of data retained in it.

### <Operation>

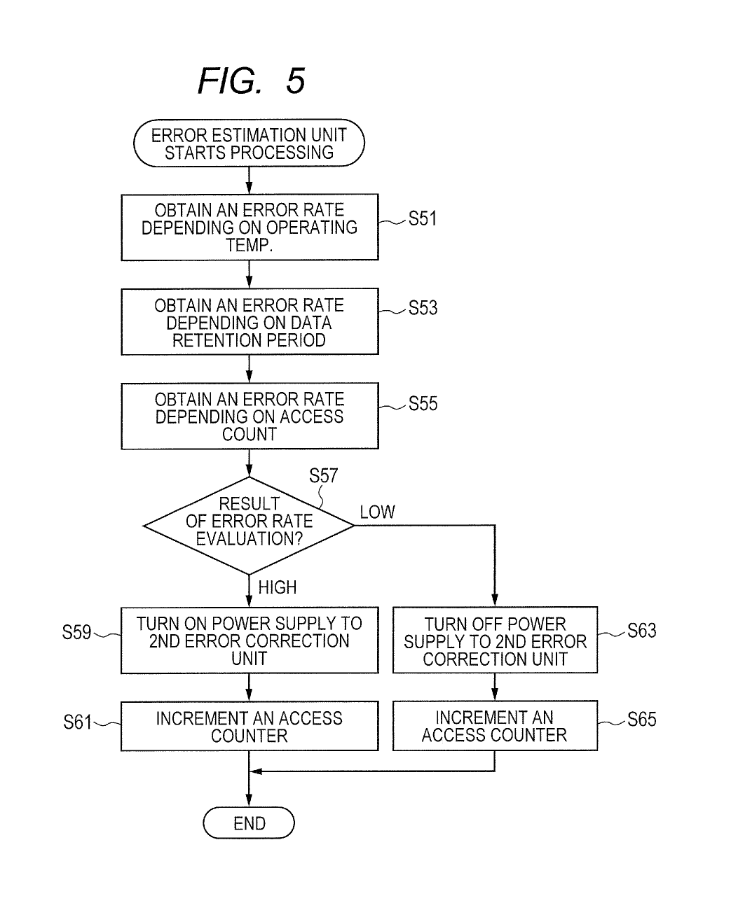

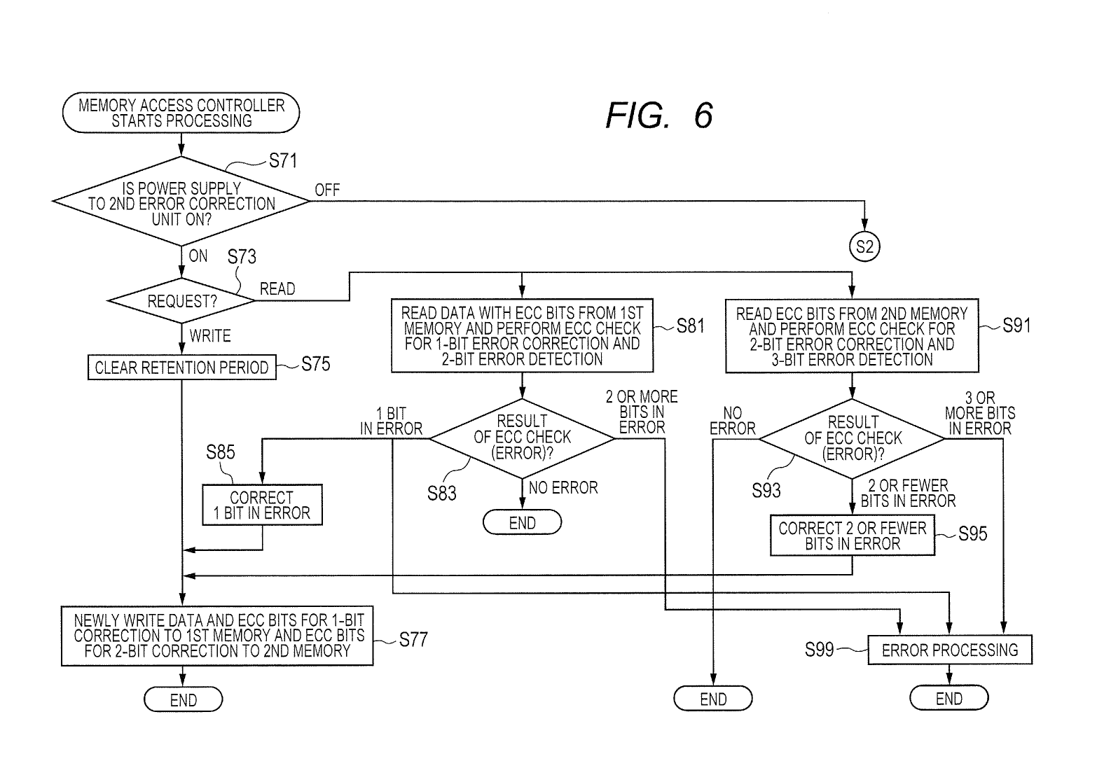

Referring to FIG. 5 and so on, then, operation of the semiconductor memory device 1 is described. In the present embodiment, the semiconductor memory device 1 starts its operation, triggered when the memory access controller 14 receives a write request for writing data to the first memory unit 22 or a read request for reading data from the first memory unit 22 from an external entity. The memory access controller 14 specifies a line to be accessed within the memory and outputs a control signal to the error rate estimation unit 12, thereby causing the error rate estimation unit 12 to start estimating an error rate for the line to be accessed.

### <Operation of Estimating an Error Rate by the Error Rate Estimation Unit 12>

FIG. 5 is a flowchart illustrating operation of the error rate estimation unit 12.

At step S51, the error rate estimation unit 12 reads the operating temperature of the first memory unit 22 from the temperature information retaining unit 10 and also reads memo characteristics related information which represents a correlation between the operating temperature of the first memory unit 22 and a data error rate from the memory characteristics retaining unit 16. The error rate estimation unit 12 makes a comparison between the thus read operating temperature and the memory characteristics related information and obtains a data error rate depending on the operating temperature of the first memory unit 22.

At step S53, the error rate estimation unit 12 reads the data retention period of the line to be accessed within the memory (time elapsed since the line was last accessed) from the data retention period retaining unit 19 and also reads memory characteristics related information which represents a correlation between the data retention period of the first memory unit 22 and a data error rate from the memory characteristics retaining unit 16. The error rate estimation unit 12 makes a comparison between the thus read data retention period and the memory characteristics related information and obtains a data error rate depending on the data retention period of the first memory unit 22.

At step S55, the error rate estimation unit 12 reads the access count for the line to be accessed within the memory from the access counts retaining unit 17 and also reads memory characteristics related information which represents a correlation between the access count to the first memory unit 22 and a data error rate from the memory characteristics retaining unit 16. The error rate estimation unit 12 makes a comparison between the thus read access count and the memory characteristics related information and obtains a data error rate depending on the access count to the first memory unit 22.

At step S57, the error rate estimation unit 12 compares the largest value of data error rate among the data error rates obtained at the steps S51, S53, and S55 with a predetermined threshold value (a value from 0% to 100%; the threshold value is determined according to requirements called for the semiconductor memory device 1 in terms of reliability of data retained therein). If the value of data error rate, thus compared, exceeds the predetermined threshold value, the error rate estimation unit 12 determines that the data error rate is “high”. If the data error rate after multiplication is less than or equal to the predetermined threshold value, the error rate estimation unit 12 determines that the data error rate is “low”. If the error rate estimation unit 12 determines that the data error rate is “high” at step S57, the error rate estimation unit 12 proceeds to step S59. If the error rate estimation unit 12 determines that the data error rate is “low” at step S57, the error rate estimation unit 12 proceeds to step S63.

Subsequent operation if the error rate estimation unit 12 determines that the data error rate is “high” is described. At step S59, the error rate estimation unit 12 outputs a control signal to the power supply controller 13 and instructs the power supply controller 13 to supply power to the second error correction unit 30. Upon being so instructed by the error rate estimation unit 12, the power supply controller 13 supplies power to the second error correction unit 30. Also, the power supply controller 13 outputs a control signal to the memory access controller 14, thereby notifying the memory access controller 14 that it supplies power to the second error correction unit 30.

At step S61, the error rate estimation unit 12 updates the access count for the line to be accessed within the memory and stores the updated value into the access counts retaining unit 17.

Subsequent operation if the error rate estimation unit 12 determines that the data error rate is “low” is described. At step S63, the error rate estimation unit 12 outputs a control signal to the power supply controller 13 and instructs the power supply controller 13 not to supply power to the second error correction unit 30. Upon being so instructed by the error rate estimation unit 12, the power supply controller 13 stops power supply to the second error correction unit 30. Thereby, the second error correction unit 30 stops its operation. Also, the power supply controller 13 outputs a control signal to the memory access controller 14, thereby notifying the memory access controller 14 that it has stopped power supply to the second error correction unit 30.

At step S65, the error rate estimation unit 12 updates the access count for the line to be accessed within the memory and stores the updated value into the access counts retaining unit 17.

### <Operation for Memory Access and Data Correction by the Memory Access Controller 14>

Using FIG. 6 and so on, then, operation of the memory access controller 14 of the semiconductor memory device 1 is described. FIG. 6 is a flowchart illustrating how memory access and error correction are controlled by the memory access controller 14.

At step S71, the memory access controller 14 determines whether power supply to the second error correction unit 30 is performed, when notified of whether the power supply controller 13 supplies power or stops power supply to the second error correction unit 30, as a result of error rate estimation made by the error rate estimation unit 12. If the memory access controller 14 has determined that power supply to the second error correction unit 30 is performed, it proceeds to step S73; if having determined that power supply to the second error correction unit 30 is not performed, it proceeds to a process “S2” which will be described later.

### <If Power Supply to the Second Error Correction Unit 30 is Performed>

At step S73, the memory access controller 14 determines whether the memory access from an external entity is a write operation or a read operation. If determining that it is a write operation, the memory access controller 14 proceeds to step S75. If determining that it is a read operation, the memory access controller 14 executes step 81 and step 91.

### <When a Write Operation to the First Memory Unit 22 is Performed>

At step S75, the memory access controller 14 clears contents stored in the data retention period retaining unit 19 regarding the line that is write-accessed within the memory.

At step S77, the memory access controller 14 outputs write data to the first error correction unit 20 and the second error correction unit 30. When the first error correction unit 20 receives write data from the memory access controller 14, the 1-bit error corrector 21 generates ECC bits and the first memory unit 22 associatively stores the write data and the ECC bits generated by the 1-bit error corrector 21. When the second error correction unit 30 receives write data from the memory access controller 14, the 2-bit error corrector 31 generates ECC bits and the second memory unit 32 stores the ECC bits generated by the 2-bit error corrector 31.

<When a Read Operation from the First Memory Unit 22 is Performed>

Descriptions are then provided for operation of the semiconductor memory device 1, when the memory access controller 14 reads data from the first memory unit 22.

At step S81, the memory access controller 14 accesses the first memory unit 22 according to an address to be accessed and reads stored data and ECC bits 24 stored at the specified address. The 1-bit error decision unit 23 performs processing for 1-bit error correction and 2-bit error detection, based on the ECC bits of the stored data and ECC bits 24 which have just been read.

At step S83, if one bit in error as a result of error detection using the ECC bits, the 1-bit error decision unit 23 proceeds to steps S85 and also notifies the memory access controller 14 that one bit is in error. The memory access controller 14 proceeds to step S99 and performs error processing to display the fact that one bit is in error. At step S83, if the 1-bit error decision unit 23 determines that two or more bits are in error, it notifies the memory access controller 14 that two or more bits are in error. The memory access controller 14 proceeds to step S99 and performs error processing to display the fact that two or more bits are in error. At step S83, if no error is detected as a result of error detection by the 1-bit error decision unit 23, the data read from the first memory unit 22 is output to the memory access controller 14.

At step S85, the 1-bit error decision unit 23 performs 1-bit error correction. Besides, the memory access controller 14 performs processing to respond to 2-bit error detection as well.

At step S91, from the second memory unit 32, the memory access controller 14 reads ECC bits 34 associated with the data read from the first memory unit 22, according to an address to be accessed.

At step S93, the 2-bit error decision unit 33 performs processing for error correction. The 2-bit error decision unit 33 performs processing for 2-bit error correction and 3-bit error detection based on the ECC bits 34. At step S93, if it is determined that no error is detected, the 2-bit error decision unit 33 notifies the memory access controller 14 that no error is detected and the process terminates. At step S93, if is determined that two or fewer hits are in error as a result of error detection using the ECC bits 34 by the 2-bit error decision unit 33, the 2-bit error decision unit 33 proceeds to step S95. At step S93, if it is determined that three or more bits are in error, the 2-bit error decision unit 33 notifies the memory access controller 14 that three or more bits are in error. The memory access controller 14 proceeds to step S99 and performs error processing to display the fact that three or more bits are in error.

### <Operation if Power Supply to the Second Error Correction Unit 30 is Turned OFF>

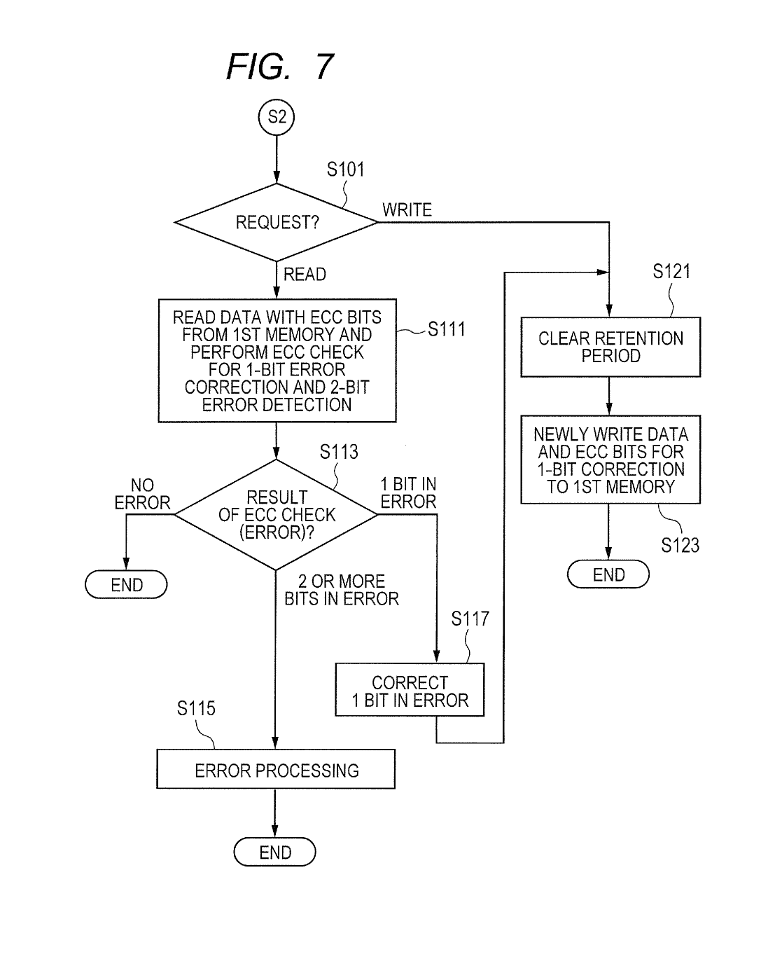

Descriptions are then provided for operation if power supply to the second error correction unit 30 is turned OFF, as determined at step S71. FIG. 7 is a flowchart illustrating operation of the semiconductor memory device 1, if power supply to the second error correction unit 30 is turned OFF.

At step S101, the memory access controller 14 determines whether the memory access from an external entity is a write operation or a read operation. If determining that it is a write operation, the memory access controller 14 proceeds to step S121. If determining that it is a read operation, the memory access controller 14 proceeds to step S111.

### <When a Read Operation is Performed>

At step S111, the memory access controller 14 accesses the first memory unit 22 according to an address to be accessed and reads stored data and ECC bits 24 stored at the specified address. The 1-bit error decision unit 23 performs processing for 1-bit error correction and 2-bit error detection, based on the ECC bits of the stored data and ECC bits 24 which have just been read.

At step S113, if no error is detected as a result of error detection using the ECC bits, the 1-bit error decision unit 23 outputs the read data to the memory access controller 14. If two or more bits are in error as a result of error detection using the ECC bits, the 1-bit error decision unit 23 notifies the memory access controller 14 that two or more bits are in error and the process proceeds to step S115. At step S115, the memory access controller 14 performs error processing to display the fact that two or more bits are in error.

At step S113, if one bit is in error as a result of error detection using the ECC bits, the 1-bit error decision unit 23 proceeds to step S117 and also notifies the memory access controller 14 that one bit is in error.

At step S121, the memory access controller 14 clears contents stored in the data retention period retaining unit 19, associated with the address to be accessed.

At step S123, the 1-bit error decision unit 23 outputs data in which one bit in error was corrected to the 1-bit error corrector 21 and causes the 1-bit error corrector 21 to generate ECC bits based on the error corrected data. The 1-bit error corrector 21 stores generated ECC bits and the error corrected data into the first memory unit 22. The 1-bit error decision unit 23 outputs the error corrected data to the memory access controller 14.

### <When a Write Operation is Performed>

At step S101, if it is determined that the memory access from an external entity is a write, the memory access controller 14 proceeds to step S121.

At step S121, the memory access controller 14 clears contents stored in the data retention period retaining unit 19, associated with the address to be accessed.

At step S123, the memory access controller 14 outputs write data to the 1-bit error corrector 21. The 1-bit error corrector 21 generates ECC bits based on the write data and stores the write data and the generated ECC bits in association with the address to be accessed into the first memory unit 22.

### <Modifications>

According to the foregoing description of the embodiment, the error rate estimation unit 12 compares temperature information, data retention period, and memory access count with memory characteristics related information stored in the memory characteristics retaining unit 16 and determines whether the data error rate is “high” or “low” based on the highest one of data error rates obtained.

Another approach not restricted to this is possible. Error rates are obtained depending on each of the parameters of temperature information, data retention period, and memory access count. For example, it may be expedient to set a threshold value for determining whether the data error rate is “high” or “low” in terms of each of these parameters. In this case, the error rate estimation unit 12 compares an error rate with a threshold value with respect to each parameter. In consequence, for example, if the error rate regarding any parameter is more than the threshold value, the error rate estimation unit 12 may determine that the error rate is “high”.

Besides, the error rate estimation unit 12 may make a multiplication of error rates which are obtained depending on each of the parameters of temperature information, data retention period, and memory access count and may obtain a value produced by the multiplication as an estimated value of data error rate. Depending on the estimated value thus obtained, the memory access controller 14 may control power supply to the first error correction unit 20 and the second error correction unit 30.

While embodiments have been described hereinbefore, a combination of these embodiments may obviously be possible.

While the invention made by the present inventors has been described specifically based on its embodiments hereinbefore, it will be obvious that the present invention is not limited to the described embodiments and various modifications may be made therein without departing from the scope of the invention.

What is claimed is:

1. A semiconductor memory device comprising:
a storage unit for storing one or more sorts of operating environment information which represents a correlation between an operating environment of a memory and a data error rate;
an error correction unit having a plurality of error correction functions for correcting, based on data that is stored in said memory, a bit error in said data;
an estimation unit that retrieves an operating environment parameter indicating an operating environment of said memory and estimates an error rate of data that is to be accessed within the memory, based on said operating environment information and said operating environment parameter; and
a control unit that selects at least one of said error correction functions to be used for error correction based on the estimated error rate and supplies power to at least one circuit implementing the selected at least one of said error correction functions.

2. The semiconductor memory device according to claim 1,
wherein said error correction unit comprises:
a 1-bit error corrector that corrects a 1-bit error for executing one of said error correction functions; and
a 2-bit error corrector that corrects a 2-bit error for executing another one of said error correction functions, and
wherein said control unit selects both said 1-bit error corrector and said 2-bit error corrector and supplies power to both said 1-bit error corrector and said 2-bit error corrector when said error rate is more than a predetermined threshold, and does not select said 2-bit error corrector and stops power supply to said 2-bit error corrector when said error rate is less than the predetermined threshold value.

3. The semiconductor memory device according to claim 1,
wherein said estimation unit estimates said error rate based on said operating environment information for each line that is to be accessed within said memory, and
wherein said control unit controls power supply to said error correction functions when each line is actually accessed, based on said error rate estimated for each line by said estimation unit.

4. The semiconductor memory device according to claim 1,
wherein said storage unit is for storing access counts to said memory as said operating environment information, and
wherein said estimation unit retrieves an access count to said memory as said operating environment parameter.

5. The semiconductor memory device according to claim 1,
wherein said storage unit is for storing an operating temperature of said memory as said operating environment information, and
wherein said estimation unit retrieves an operating temperature of said memory as said operating environment parameter.

6. The semiconductor memory device according to claim 1,
wherein said storage unit is for storing a data retention period of said memory as said operating environment information, and
wherein said estimation unit retrieves a data retention period of said memory as said operating environment parameter.

7. A method for power supply control in a semiconductor memory device,
said semiconductor memory device comprising a storage unit for storing one or more sorts of operating environment information which represents a correlation between an operating environment of a memory and a data error rate, and an error correction unit having a plurality of error correction functions for correcting, based on data that is stored in said memory, a bit error in said data,
said method comprising the steps, which are performed by said semiconductor memory device, of:
retrieving an operating environment parameter indicating an operating environment of said memory and estimating an error rate of data that is to be accessed within the memory, based on said operating environment information and said operating environment parameter; and
selecting at least one of said error correction functions to be used for error correction based on the estimated error rate and supplying power to the selected at least one of said error correction functions.
